(19) United States
(12) Patent Application Publication
(10) Pub. No.: US 2004/0240241 A1
(43) Pub. Date: Dec. 2, 2004

(54) Voltage regulating device for charging pump

(76) Inventors: Lung-Yi Chueh, Taoyuan City (TW); Yu-Shen Lin, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/647,708

(22) Filed: Aug. 25, 2003

(30) Foreign Application Priority Data
May 29, 2003 (TW) 092114628

(51) Int. Cl. H02M 3/18

(52) U.S. Cl. 363/60

(57) ABSTRACT

A voltage regulating device for charging pump is disclosed. The charging pump outputs an output voltage according to the operation of clock signals. The voltage regulating device includes a number of voltage regulating capacitors whose one terminal is coupled to the output terminal of the charging pump while the other terminal receives inverse clock signals.

This application claims the benefit of Taiwan application Serial No. 92114628, filed May 29, 2003.

### BACKGROUND OF THE INVENTION

1. Field of the Invention

The invention relates in general to a voltage regulating device, and more particularly to a voltage regulating device for charging pump.

2. Description of the Related Art

Charging pumps can be used to increase voltage. Take the writeable flash memory for example: ordinary reading only requires a low voltage, e.g., 3V, whereas writing requires a high voltage, e.g. 12V. While ordinary integrated circuit chips (IC chips) normally have only a power supply of small voltage, e.g. 3V, a charging pump can herein be used to increase the direct current (DC) voltage if a larger-than-3V operating voltage, e.g. 12 V, is needed.

Conventional charging pumps have a number of varieties such as two-phase charging pump, four-phase charging pump, etc. Herein a two-phase charging pump is illustrated for elaboration. Please refer to FIG. 1, a schematic circuit diagram for a conventional two-phase charging pump. Two-phase charging pump 100 includes diodes D1, D2, D3, and D4, capacitors C1, C2, and C3. For the convenience of elaboration, diodes D1, D2, D3, and D4 are assumed to be ideal diodes with zero turn-on voltage. The positive electrode of diode D1 is coupled to DC power supply Vdd while the negative electrode of diode D1 is coupled to node N1 together with the positive electrode of diode D2 and one terminal of capacitor C1, wherein the other terminal of capacitor C1 receives clock signal CLK. The negative electrode of diode D2 is coupled to node N2 together with the positive electrode of diode D3 and one terminal of capacitor C2, wherein the other terminal of capacitor C2 receives inverse clock signal CLK′, inverse of clock signal CLK. The negative electrode of diode D3 is coupled to node N3 together with the positive electrode of diode D4 and one terminal of capacitor C3, wherein the other terminal of capacitor C3 receives clock signal CLK. The negative electrode voltage of diode D4 is exactly the charging pump output voltage Vo.

FIG. 2A is a schematic voltage diagram for the nodes of a charging pump. The voltage for DC power supply Vdd is 3V; the high level and low level voltages for clock signal CLK are 3V and 0V respectively; the initial voltage for node N1 is 3V. When the voltage of clock signal CLK changes to high level, the cross voltage of capacitor C1 still remains at 3V causing V(N1), the voltage of node N1, to be raised to 6V. Similarly, V(N2), the voltage of node N2, is raised to 9V while V(N3), the voltage of node N3, is raised to 12V. Consequently, output voltage Vo is raised to 12V.

FIG. 2B is a schematic output voltage diagram for a conventional charging pump. While the charging pump raises the voltage step by step, output voltage Vo will eventually be raised to 12V. Due to the discharge effect of capacitor C3, however, output voltage Vo starts to drop slightly when the clock signal CLK coupled to capacitor C3 is at low level, but starts to rise up slightly when clock signal CLK is at high level. In worst cases, output voltage Vo will swing for ±1V and result in an undesired ripple-like wave form of the output voltage.

### SUMMARY OF THE INVENTION

It is therefore an object of the invention to provide a voltage regulating device for charging pump.

According to the object of the invention, a voltage regulating device for charging pump is provided. The charging pump outputs an output voltage according to the operation of clock signals. The voltage regulating device includes a number of voltage regulating capacitors whose one terminal is coupled to the output terminal of the charging pump while the other terminal receives inverse clock signals.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic circuit diagram for a conventional two-phase charging pump;

FIG. 2A is a schematic voltage diagram for the nodes of a charging pump;

FIG. 2B is a schematic output voltage diagram for a conventional charging pump;

FIG. 3 is a schematic diagram for a voltage regulating device for charging pump according to a preferred embodiment of the invention;

FIG. 4 shows the wave form of charging pump output voltage obtained according to a voltage regulating device of the invention; and

FIG. 5 is a schematic diagram illustrating the application of the voltage regulating device according to the invention in a four-phase charging pump.

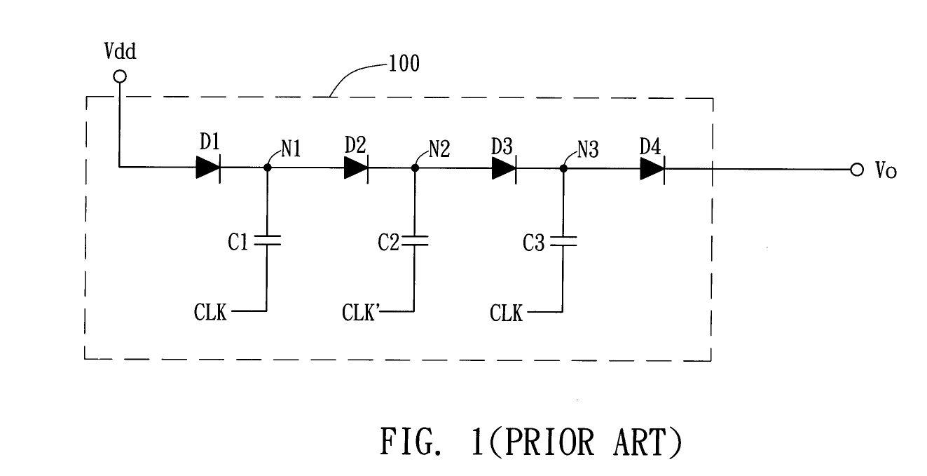

### DETAILED DESCRIPTION OF THE INVENTION

The charging pump uses the capacitor to raise the DC (direct current) voltage and inevitably results in a slightly rippled wave form of the output voltage. The spirit of the invention lies in coupling a voltage regulating wave form, which is opposite to the ripple of output voltage Vo, to the output terminal of the charging pump such that the wave form of output voltage Vo goes smoothly and that the quality of power supply can be enhanced.

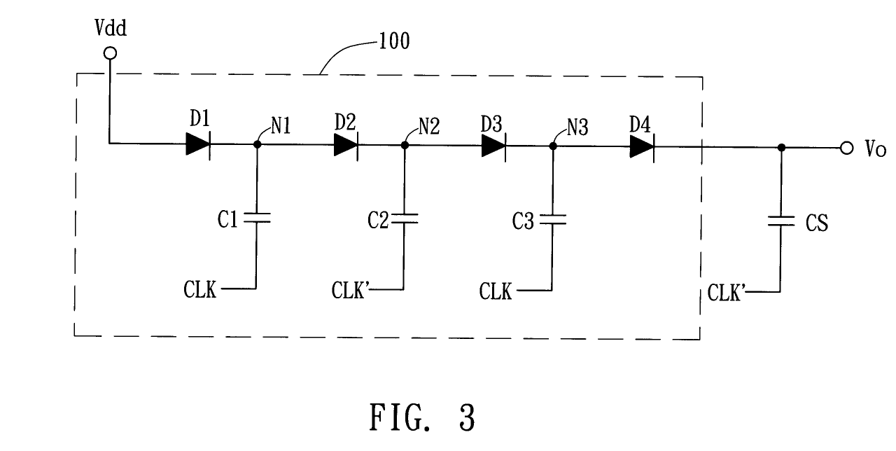

FIG. 3 is a schematic diagram for a voltage regulating device for charging pump according to a preferred embodiment of the invention. In the embodiment, the charging pump is illustrated using two-phase charging pump 100. The voltage regulating device is coupled to two-phase charging pump 100 wherein charging pump 100 raises the level of input voltage Vdd to the level of output voltage Vo according to clock signal CLK. The voltage regulating device includes voltage regulating capacitors Cs whose one terminal is coupled to the output terminal of charging pump 100 while the other terminal receives inverse clock signal CLK′, inverse of clock signal CLK.

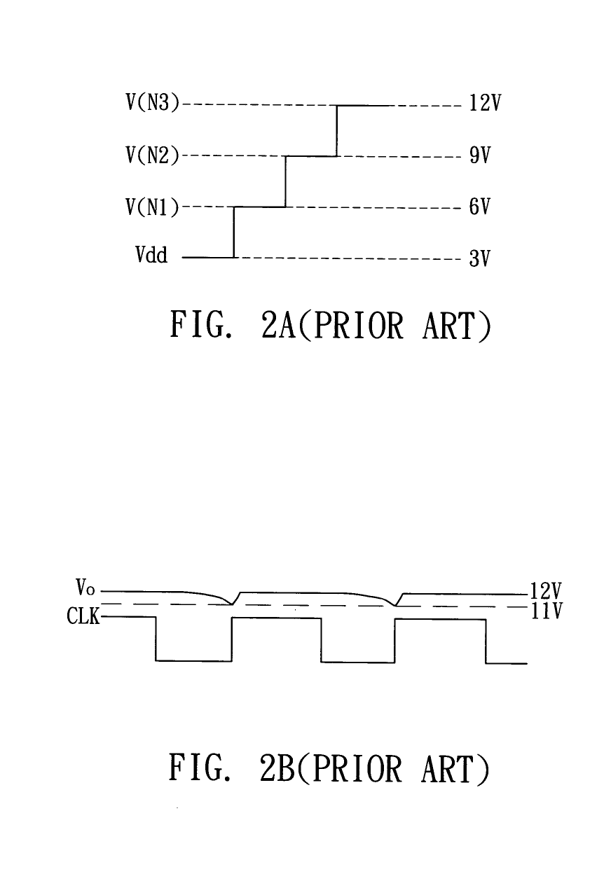

First of all, the operating principles for charging pump 100 are discussed below. The initial voltage for node N1 is 3V. When the voltage of clock signal CLK changes to high level, the cross voltage of capacitor C1 still remains at 3V causing V(N1), the voltage of node N1, to be raised to 6V. Similarly, V(N2), the voltage of node N2, is raised to 9V while V(N3), the voltage of node N3, is raised to 12V. Consequently, output voltage Vo is raised to 12V. However, as illustrated in FIG. 2B, when clock signal CLK is at low level, output voltage Vo drops slightly due to the discharge effect of capacitor C3 resulting in an undesired wave form of the output voltage. Particularly when the voltage of clock signal is raised to high level, output voltage Vo will have an abrupt increase leading to an unstable output of voltage.

According to the received inverse clock signal CLK′, the voltage regulating capacitor in the invention couples a voltage regulating wave to the output terminal of the charging pump. Since the inverse clock signals received by voltage regulating capacitors Cs are the inverse signals of the last scaled clock signals of the charging pump, capacitors Cs can provide appropriate bias in case that the output voltage Vo is insufficient to provide enough bias. When output voltage Vo starts to drop down, the voltage regulating wave couples a positive voltage to output voltage Vo and the output voltage Vo falls smoothly; when output voltage Vo starts to rise up, the voltage regulating wave couples a negative voltage to output voltage Vo and the output voltage Vo rises smoothly. In doing so, the wave form of output voltage Vo becomes more regulated.

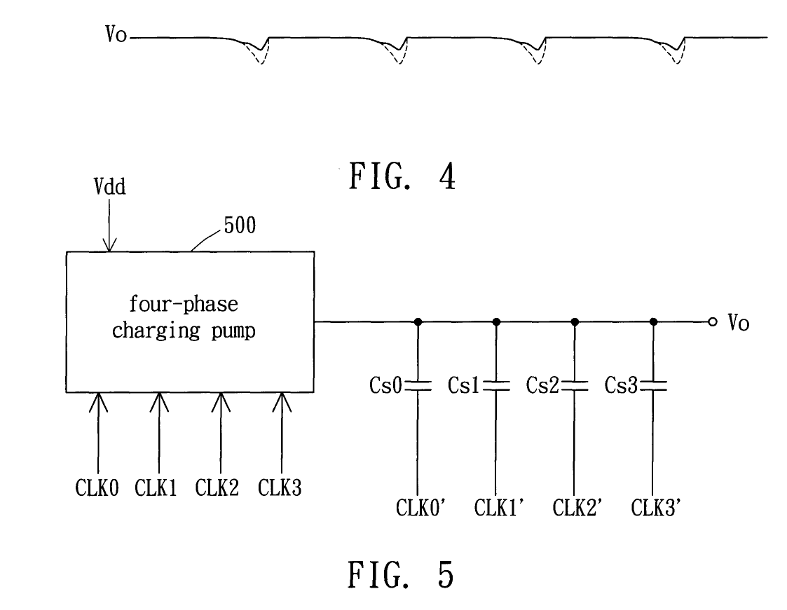

FIG. 4 shows the wave form of charging pump output voltage obtained according to a voltage regulating device of the invention. Troughs in dotted lines are wave form before voltage regulating and are sharper than those in solid lines which are wave form after voltage regulating. This comparison shows that the invention does help to regulate the output voltage.

The voltage regulating capacitors Cs of the invention are appropriately selected capacitors whose capacitance is relatively small compared to the capacitance which the output terminal of the charging pump embodies. Amplitude of inverse clock signal CLK′ received by voltage regulating capacitors Cs will be smaller and become more regulated without affecting the value of output voltage Vo, because the voltage of inverse clock signal CLK′ has already been divided by voltage regulating capacitors Cs and the loading capacitor.

FIG. 5 is a schematic diagram illustrating the application of the voltage regulating device according to the invention in a four-phase charging pump. Since four-phase charging pump operates according to four sets of clock signals, namely, CLK0, CLK1, CLK2, and CLK3, four sets of voltage regulating devices are needed. These voltage regulating devices include voltage regulating capacitors Cs0, Cs1, Cs2, and Cs3 which receive inverse clock signals CLK0′, CLK1′, CLK2′, and CLK3′ respectively, to supplement the insufficient bias of output voltage according to the above mentioned principles and produce a more regulated wave form of output voltage accordingly.

The voltage regulating device disclosed in the above embodiment of the invention has the advantage of regulating the output voltage of the charging pump.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A voltage regulating device for a charging pump, wherein the charging pump outputs an output voltage according to a clock signal while the voltage regulating device comprises:
a voltage regulating capacitor whose one terminal is coupled to an output terminal of the charging pump while the other terminal receives an inverse clock signal.

2. The voltage regulating device for a charging pump according to claim 1, wherein the charging pump outputs the output voltage to a load while the capacitance of the voltage regulating capacitor is smaller than the capacitance of the load.

3. The voltage regulating device for charging pump according to claim 1, wherein the charging pump is two-phase.

4. A voltage regulating device for a charging pump, wherein the charging pump outputs an output voltage according to a first clock signal, a second clock signal, a third clock signal, and a fourth clock signal while the voltage regulating device comprises:
a first voltage regulating capacitor whose one terminal is coupled to an output terminal of the charging pump while the other terminal receives a first inverse clock signal;
a second voltage regulating capacitor whose one terminal is coupled to the output terminal of the charging pump while the other terminal receives a second inverse clock signal;
a third voltage regulating capacitor whose one terminal is coupled to the output terminal of the charging pump while the other terminal receives a third inverse clock signal; and
a fourth voltage regulating capacitor whose one terminal is coupled to the output terminal of the charging pump while the other terminal receives a fourth inverse clock signal.

5. The voltage regulating device for a charging pump according to claim 4, wherein the charging pump outputs the output voltage to a load while the capacitance of the first, the second, the third and the fourth capacitor is smaller than the capacitance of the load.
